(19) United States
(12) Patent Application Publication
(10) Pub. No.: US 2005/0193632 A1
(43) Pub. Date: Sep. 8, 2005

(54) DOOR FRAME SYSTEM UTILIZING HEADER ASSEMBLY WITH CONCEALED AUTOMATIC OPERATOR

(76) Inventors: David Orban, Dana Point, CA (US); David Stiles, Modesto, CA (US)

Correspondence Address: TIMOTHY J MARTIN, PC, 9250 W 5TH AVENUE, SUITE 200, LAKEWOOD, CO, 80226, US

(21) Appl. No.: 10/906,733

(22) Filed: Mar. 3, 2005

Related U.S. Application Data
(60) Provisional application No. 60/550,035, filed on Mar. 3, 2004.

(51) Int. Cl. E05F 11/24

(52) U.S. Cl. 49/340

(57) ABSTRACT

A header is provided for use with an automatic door that can form a door system including a door frame. A door operator is disposed in the interior of a header housing such that the operator is located above the door when the door is closed. A crank arm links the operator to the door such that the operator acts to open the door. In the disclosed embodiment, the housing has an inverted U-shaped configuration with a flange portion to affix a frame plate to define a frame head piece. A cover plate may be used to enclose the housing interior. In this embodiment, a sub-frame mounts on the cover plate, and the crank arm extends laterally through a slot in the sub-frame. The sub-frame can define a top strike for the door.

### FIELD OF THE INVENTION

The present invention broadly concerns door systems including frames with headers used to allow ingress and egress. More particularly, the present invention relates to door systems wherein the door may be automatically opened. The invention particularly concerns a door system wherein the operator for an automatic door is hidden from view.

### BACKGROUND OF INVENTION

Various closure structures have been associated with entryways of dwellings and building throughout history. These closure structures range from simple draped fabrics, to a standard hinge door and to more elaborate mechanical devices that are used in commercial applications. Many such doors require the manual operation by the person seeking the ingress or egress into the space accessed by the closure. Many commercial applications, though, employ automated doors which open or close.

In modern commercial buildings, automatic doors have become commonplace. Usually automatic doors are one of two types, but, in either event, these automatic doors are typically electronically operated so that, as a person approaches, the door moves from a closed position to an open position. Automatic doors typically respond to an input signal that senses the presence of a person. In the early days of automatic doors, a pressure pad was placed in front of the door on the walking surface. When a person stepped on the pressure pad, the weight of the person closed a switch that sent a signal to the door operating mechanism to cause the mechanism to open the door. In more recent years, electric eyes, motion detectors and proximity detectors have been used as sensors to determine the presence of a person at the entryway. When a person enters the sensor zone, a signal is produced that causes the door operating mechanism to open the door.

One type of automated door is the sliding automated door. Automated sliding doors are typically constructed as a unit when a slide panel is slightly offset from but is parallel to a fixed panel. The slide panel and fixed panel are typically mounted in a frame so that they are parallel to the opening for the door. The slide panel slides relative to the fixed panel in this plane to create a doorway opening for ingress and egress. Often, a pair of such units are placed in end-to-end relation so that the slide panels abut one another in a common plane. In such configurations, the presence of an operative signal causes both slide panels to slide away form one another presenting a doublewide entry opening for ingress and egress.

The second type of automatic door is a swinging door that is hinged along a hinge jamb. The door then swings between the open and closed position about the hinge jamb. The edge of the door opposite the hinged edge, which may be referred to as the nose stile, typically abuts a strike jamb when in the closed position. Sometimes two such swinging doors are used in a single opening. These nose stiles of these two doors can either abut a central strike jamb or come together in a confronting relationship when in the closed position. Whether the automatic door is a single or double door, an electromechanical operator is secured to the exterior of the doorframe for each door. The operator includes a crank arm that is secured to the door. As the operator drives the crank arm, the crank arm forces the door from the closed position to the open position. The door may then return to the closed position either by reversing the operator or by allowing the door to return, for example, against a spring biasing force.

As noted, the operator for an automatic swinging door is typically mounted exteriorly of the frame. This presents two disadvantages. On one hand, the location of the operator exteriorly of the frame exposes the electromechanical components to the environment. On the other hand, and possibly more importantly, the presence of the operator on the exterior of the frame is aesthetically unappealing. Not only are these operator units and their associated crank arms ungainly, but also the projection of such devices tends to interfere with the flow of architectural design highly often desired in upscale applications. Accordingly, architects tend to find the presence of such door operators unappealing. This problem has existed since these exteriorly mounted operators were first used.

Accordingly, there is a need for improved constructions of doorframes and door systems utilizing such systems. There is a further need for automatic door systems that eliminate the appearance of externally positioned electromechanical actuators. The present invention is directed to meeting these needs.

### SUMMARY OF THE INVENTION

It is an object of the present invention to provide a new and useful header used in a doorframe assembly in an automatic door system.

Another object of the present invention is to provide an automatic doorframe construction including a header so that the operator for the automatic door may be concealed from view.

It is a further object of the present invention to provide a header and doorframe assembly which is more aesthetically pleasing.

Still a further object of the present invention is to provide a doorframe construction utilizing a header that allows for the installation of automatic hardware either before or after the doorframe is installed into a wall.

According to the present invention, then, an automatic door system is provided for use in a door opening in a wall. This automatic door system employs an improved doorframe assembly and, specifically, a header therefore. The header includes a housing having an interior, and an operator (and associated electronics) that is disposed in the interior of the housing such that the operator is located above the automatic door when the door is in a closed position. The operator acts on the door through a crank arm that links the operator to the door such that the operator can move the door from the closed position to the open position.

The housing of the header is formed in an inverted U-shaped configuration and includes a pair of opposed side walls and a top wall that interconnects that side walls. At least one side wall terminates in an outwardly projecting flange, but, in the illustrated embodiments, each side wall terminates in an outwardly projecting flange portion. A frame plate may be affixed to the flange portion so that the frame plate and the flange portion together define a frame headpiece which abuts a wall in which the doorframe is mounted.

As noted, the operator is received within the interior of this housing, and in the illustrated embodiment, a cover plate is adapted to mount onto the housing to enclose the interior thereof. A hanger bracket may be secured in the interior of the housing with the hanger bracket operative to support a mounting plate. The operator and its electronics may be then mounted on mounting plate. The crank arm that operates the door is driven by the operator. Here, the crank arm may project outwardly of the housing. To this end, the illustrated embodiment shows a sub-housing that is mounted on the cover plate, and the crank arm extends laterally through a slot formed in the sub-housing structure. This sub-housing structure, then, can define a top strike for the door. In the illustrated embodiment both ends of the housing are enclosed by means of an end wall. This end wall may be an extension of the side jambs of the doorframe.

The operator is illustrated to be an electromechanical operator including a motor and associated electronics for the automatic door. To this end, the housing can include a knockout portion adapted upon removal to allow access for electrical connections to the operator from a power supply such as AC line current. The electric motor includes a shaft that, if desired, can project through the cover plate, and a drive into the crank arm is secured to the shaft with the opposite end being slidably secured to the door.

The doorframe assembly according to the present invention is then adapted to mount a door actuator therefore. The doorframe includes a pair of side jambs, such as a hinge jamb and a strike jamb, that extend in the wall opening upwardly from a structural floor. A header housing then extends between the jambs in spaced relation to the structural floor thereby to define a top portion of the doorframe. The header housing has a header interior sized and adapted to receive and mount the operator therein so that the operator is located above the door inside of the header housing when the door is mounted in the doorframe and is in a closed position. The header housing of this doorframe, then, can be constructed as described above in this summary.

The automatic door system of the present invention accordingly includes a frame that is adapted to mount in the door opening. The frame includes first and second side jambs and a header housing extending between these side jambs. At least one door is mounted in the frame for movement between an open and a closed position, and an operator is disposed in the header interior. A crank arm then links the operator and the door so that the operator operatively acts upon the door thereby to move the door from the closed position to the open position. In this invention, it is contemplated that a pair of doors may be mounted in the frame, each door being for movement between an open position and a closed position. In such case, there is an operator associated with each of the doors, with each of the operators being received in the housing interior. Here again, the frame and, specifically, the housing may be constructed as described above in the summary.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a front view in elevation showing the upper portion of an automatic door according to the prior art with the door in a closed position;

FIG. 2 is a top plan view of the door assembly of FIG. 1 with the door shown in an open position;

FIG. 3 is a top view in partial cross-section, diagramming the abutment of the nose stile of a door abutting the strike jamb of the doorframe of FIGS. 1 and 2;

FIG. 4 is a top view in partial cross-section, illustrating a doorframe of the prior art wherein two doors are hinged in opposite directions with this figure showing the nose stiles of each door abutting its respective strike jamb;

FIG. 5 is a front view in elevation illustrating an automatic door system according to one embodiment of the present invention here showing a single door in a closed position;

FIG. 6 is a front view in elevation of a second embodiment of an automatic door system according to the present invention showing a doorframe assembly using two doors;

FIG. 7 is a perspective view of one end of the header used with the door assemblies of either FIG. 5 or FIG. 6;

FIG. 8 is an exploded end view in cross-section showing the header housing used with the header of FIG. 7;

FIG. 9 is a perspective view of a mounting plate supporting an operator for the doors of FIGS. 5 and 6 which is to be mounted in the interior of the housing of the header assembly of FIGS. 7 and 8;

FIG. 10 is a bottom view in elevation illustrating the mounting of the mounting plate, operator and electronics in the housing of FIG. 8;

FIG. 11 is a perspective view of a top portion of a door showing the slide mounting of the cam arm thereto, all according to the present invention; and

FIG. 12 is an end view in partial cross-section showing the operator unit of FIG. 9 mounted in the housing of FIG. 8 to form the header of FIG. 7 for use with the door system of the present invention.

### DETAILED DESCRIPTION OF THE EXEMPLARY EMBODIMENTS

The present invention is directed to door systems that are mounted in opening, for example, in the wall of a building. Such door systems may provide an external door permitting ingress into and egress out of the building as well as an interior door for the building. More particularly, the present invention is directed to automated door systems using an electromechanical operator and a sensor to indicate the presence of a person thereby to automatically actuate the door. The invention particularly concerns a header for use of a doorframe assembly for the door system so that the operator is hidden from view thereby providing an enhanced aesthetic appearance.

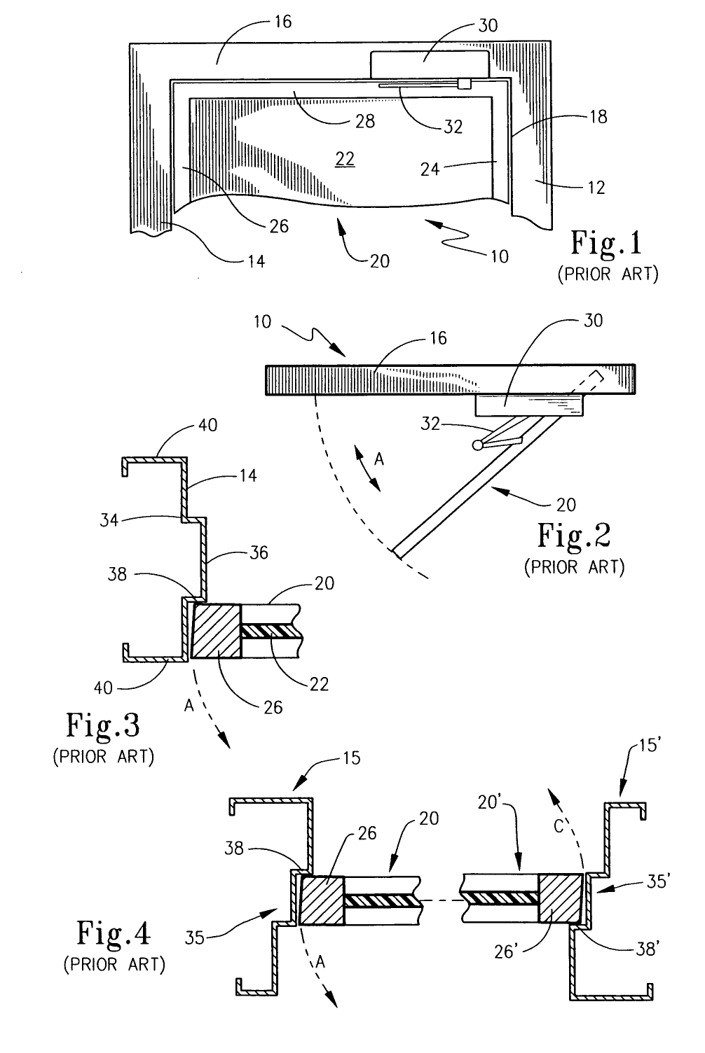

In order to introduce this invention and more fully appreciate its utility, reference is first made to FIGS. 1-4 which illustrates prior art background for the present invention. In FIGS. 1 and 2, an automatic door system 10 is illustrated and, as is known, includes a hinge jamb 12 that is in spaced apart parallel relation to a strike jamb 14. A header 16 spans the top of the door system and extends between hinge jamb 12 and strike jamb 14. A door 20 is pivotally secured to hinge jamb 12 by means of hinges, such as hinge 18 so that it may swing between a closed position (FIG. 1) and an open position (FIG. 2). Door 20 includes a door panel 22 that is supported by a hinge stile 24 that is hinged by hinge 18 to hinge jamb 12. A nose stile 26 and a top rail 28 also mount door panel 22. Nose stile 26 is operative to abut strike jamb 14 when door 20 is in the closed position.

An automatic operator 30 is mounted exteriorly to header 16 in order to automatically operate door 20 and move door 20 from the closed position to the open position in the direction of arrow “A”. To this end, operator 30 is in any suitable device, but is typically an electromechanical operator that includes associated electronics to sense the presence of a person at the doorway. As is known, such detectors can include current devices, such as pressure pads or mats, photo electric devices, proximity detectors, motion detectors and the like, or other devices as may be hereinafter developed. In any event, upon detecting the presence of a person, operator 30 is activated to move a crank arm, such as articulating crank arm 32, thereby to pivot door 20 on its hinges. As is illustrated in FIG. 3, a typical strike jamb 14 for a commercial door includes an elongated formed metal piece including a base 34 providing with a raised rectangular ridge 36 that provides a strike margin 38 for door 20 a pair of flanges 40 project oppositely of ridge 36 in spaced relation to one another.

It is also known to provide double doors which may swing oppositely in the direction of arrows “B” and “C” and is shown in FIG. 4. Here, doors 20 and 20′ respectively include nose stiles 26 and 26′ which respectively abut strike margin 38 and 38′, respectively, on strike jambs 15 and 15′. To this end, strike jambs 15 and 15′ are each provided with a base 35 and 35′ formed in a stepwise manner so as to create strike margins 38 and 38′. Alternatively, as is known, the nose stiles of the doors may confront one another in the closed position.

It should be appreciated that the present invention may be employed with a wide variety of door frames whether they be single door frames as shown in FIGS. 1-3 or frames for double doors, such as shown in FIG. 4. In addition, the present invention may be employed with doorframes of different configurations than that described with the introductory prior art.

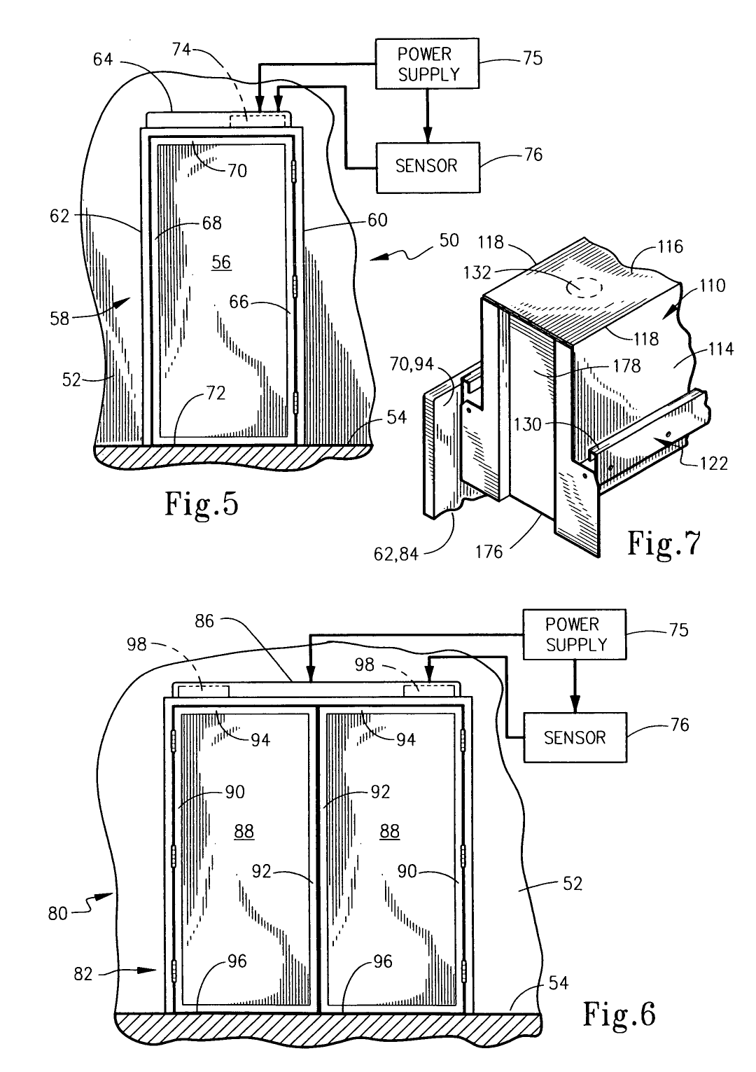

Accordingly, the present invention is introduced in FIGS. 5 and 6. In FIG. 5, automatic door system 50 is shown mounted in an opening in a wall 52 above a structure floor 54. Door system 50 includes a door 56 mounted in a frame 58 that includes a hinge jam 60, a strike jam 62 and a header 64. Door 56 includes a hinge stile 66, a nose stile 68, and top rail 70 and a bottom rail 72. Header 70 encloses an operator 74 (shown in phantom) as described more thoroughly below. Door system 50 also includes a sensor 76 that is a detector of any type known in the art or hereinafter developed. For example, the sensor may well be a pressure pad, motion detector, proximity detector, photocell, etc. Sensor 76 and operator 74 are powered by a power source or supply 75. Sometimes wall mounted push buttons may be employed to activate the operator 74, so that “sensor” should be understood to include such manually activated push buttons.

As is illustrated in FIG. 6, the present invention also contemplates the use of the invention for door systems having multiple doors. Here, it may be seen that door system 80 is mounted in an opening in wall 52 above structural floor 54. Door system 80 includes a frame 82 that includes a pair of hinge jambs 84 and a header 86 that extends between hinge jambs 84. A pair of doors 88 each include a hinge stile 90, a nose style 92, a top rail 94. In this embodiment, nose stiles 92 confront one another when doors 88 are in the closed position. However, it should be appreciated that a central strike jamb could be provided for frame 82 with this strike jamb positioned between nose stiles 92 when the doors 88 are in the closed position. In any event, door system 80 may also include an operator 98 (shown in phantom) for each of doors 88 and a sensor 76 and a power supply 75. If the doors are to operate independently, of course, two separate sensors 76 would be provided.

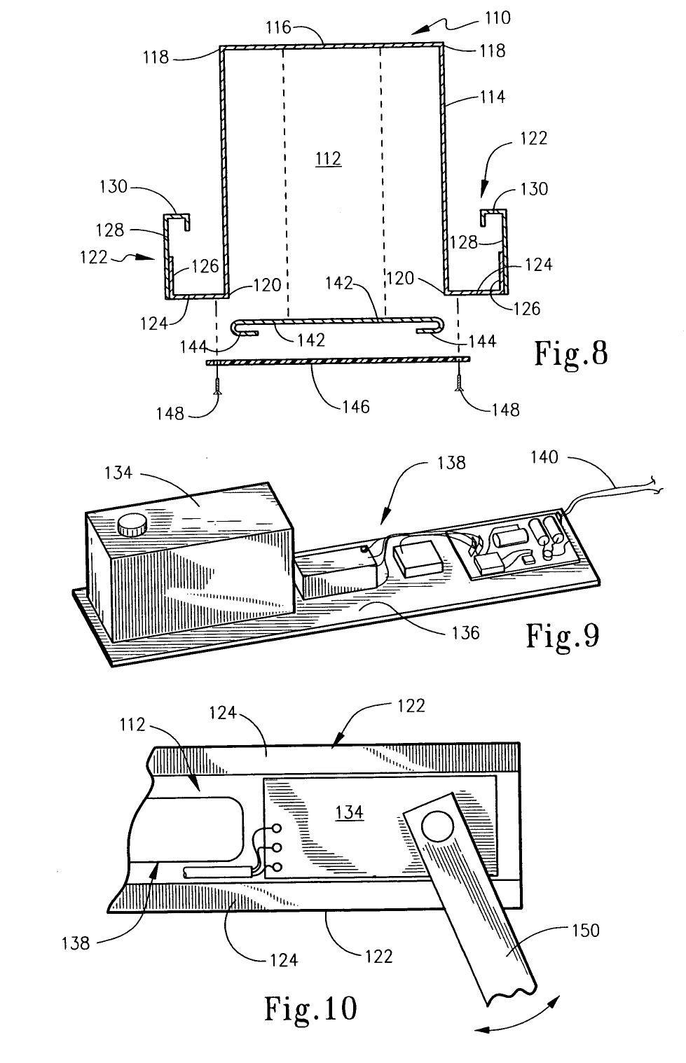

With this general structure in mind, reference is now made to FIG. 7-12 wherein the structure of a header, such as header 64 or header 86 is illustrated. Here, it may be seen that the header is formed of a housing 110 having an interior 112. Housing 110 is formed as an inverted U-shaped configuration that includes a pair of opposed sidewalls 114 that are in spaced apart, parallel relation to one another. A top wall 116 extends between and interconnects upper edges 118 of housing 110. A bottom edge 120 of housing 18 includes a headpiece 122. As is illustrated in FIG. 8, headpiece 122 is formed by a flange portion 124 that projects outwardly from edge 120 and includes an upturned lip 126. A frame plate 128 is affixed to flange portion 124 and terminates in a J-shaped edge portion 130. Frame plate 128 may be affixed by welding or other known techniques. Top wall 116 of housing 110 is also provided with one or more removable punch outs, such as punch out 132 (FIG. 7) to allow electrical interconnection of the operator, as described below.

With reference now to FIG. 9, it may be seen that an actuator in the form of electromechanical operator 134 may be mounted in any convenient manner to mounting plate 136. Mounting plate 136 also supports the electronics 138 associated with operator 134. These electronics then are placed in electrical communication with any appropriate power source, such as A/C line current by means of electrical cable 140. Electrical cable 140 may be placed in electrical communication with the power source 76 though any one of the selected punch-outs 132, noted above.

In order to mount electromechanical operator 134 in the interior 112 of housing 110, it may be seen that a pair of hanger brackets 142 are mountable to the inner surface of top wall 116 by welding or other attachment technique. Each of hanger brackets 142 have a revers 144 along one lateral edge thereof. Revers 144 are provided to engage the lateral edges of mounting plate 136 to suspend operator 134 and the associated electronics in the interior 112 of housing 110. Also, with reference to this figure, it may be seen that a cover plate 146 may be mounted to housing 110 in order to enclose interior 112. To this end, flange portion 124 are provided with threaded bores to receive screws 148 that secure cover plate 146 to flange portion 124.

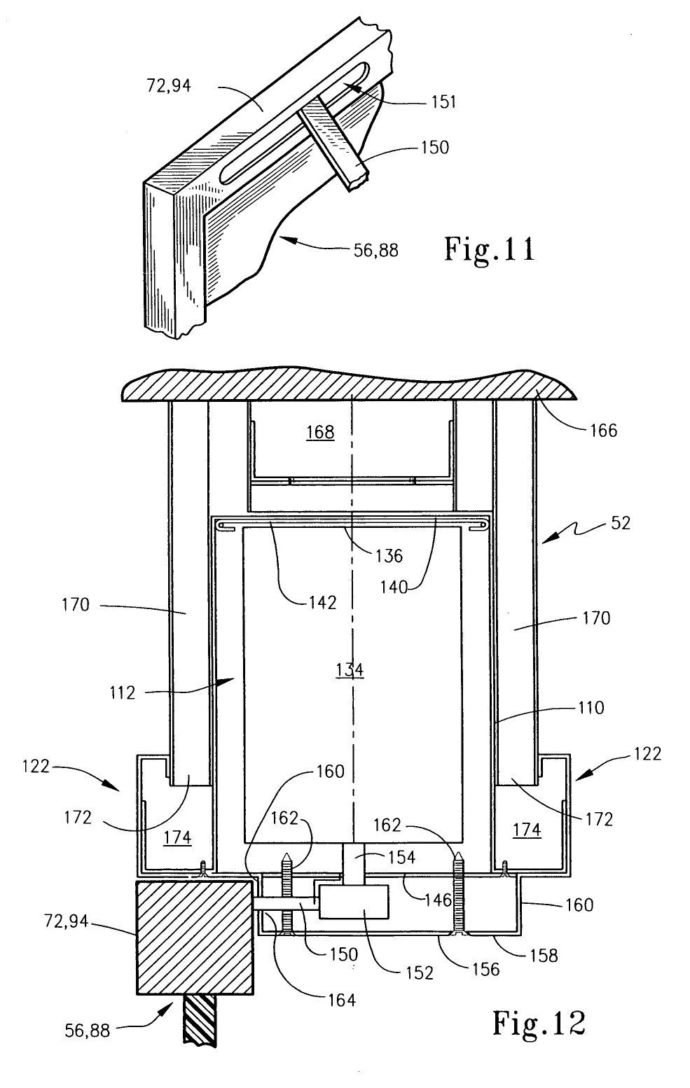

With reference to FIGS. 10 and 11, it may be seen that, when operator 134 is positioned in the interior 112, a crank arm 150 may be secured to a spindle 152 that is driven by output shaft 154 of operator 134. to this end, it should be appreciated that operator 134 may have a motor associated therewith that is part of the operator 134, as is known in the art. The opposite end of crank arm 150 is slideably secured to a door, such as door 56, 88 so as to move door 56, 88 from the closed position to the open position. To this end, crank arm 150 extends through slot 151 and is slideably secured to top rail 72, 94 of door 56, 88, respectively, in the interior thereof.

If desired spindle 152 may be enclosed by means of a sub-housing 156 that includes a bottom wall 158 and a pair of sidewalls 160. Accordingly, a portion of crank arm 152 is located in sub housing 156 with sub housing 156 being secured to cover plate 146 by means of screws 162. In order to allow the connection of crank arm 150 to top rail 72, 94, a slot 164 is formed in one of sidewalls 160 of sub housing 156, as is illustrated in FIG. 12.

With continued reference to FIG. 12 but with additional reference to FIG. 7, it may be seen that housing 110 may be received in an interior cavity formed in wall 52. As is illustrated in FIG. 11, wall 52 extends downwardly from structural member 166 of the building provided with the automatic door system. Anchorage 168 is provided, and, if desired, housing 110 may be affixed to anchorage 168 which may be in the form of wood or steel stud construction. Typically, such a wall 52 will include drywall panels 170 which may extend downwardly such that the end portions 172 thereof are located in the interior 174 of headpieces 122. With brief reference now to FIG. 7, it may be seen that the side jambs, such as jamb 176 may be cut to include a tongue 178 that forms an end wall for housing 110 so that, together with cover plate 146, the tongues completely enclose the interior 112 of housing 110. Top rail 70, 94 may be attached to headpiece 122.

From the foregoing, it should be appreciated that, as illustrated in FIG. 12, operator 134 is completely enclosed within housing 110 so that a more aesthetically pleasing appearance is presented. No ungainly operator or crank arm is visible (although the crank arm 150 is visible when the doors move to the open position). Further, it should be appreciated that the header along with operator 134 may be preassembled for mounting into a wall 52, if desired. Alternatively, the header 64, 86 may be installed into the opening of a wall so that the frame may be completely assembled. Thereafter, operator 134 and the associated electronics 138 may be mounted in housing 110 by the removal of sub-housing 156 and cover plate 146 thereby allowing access to interior 112. Moreover, it should be understood from the foregoing description that the present invention may be used with either single doors or multiple doors with there being an operator for each door located in interior 112 of the header. This also allows for ease in maintenance.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. A header for use with an automatic door that is movable between an open position and a closed position, said header adapted to extend across said door when said door is in a closed position and comprising:
(A) housing having an interior;
(B) an operator disposed in the interior of said header housing such that said operator is located above the door when said door is in the closed position; and
(C) a crank arm arm linking said operator and said door whereby said operator operatively acts on said door thereby to move said door from the closed position to the open position.

2. A header according to claim 1 wherein said housing is formed in an inverted U-shaped configuration including a pair of opposed side walls and a top wall interconnecting said side walls.

3. A header according to claim 2 wherein at least one of said side walls terminates in an outwardly projecting flange portion.

4. A header according to claim 3 including an upwardly projecting frame plate piece affixed said flange portion.

5. A header according to claim 4 wherein said flange portion and said frame plate together define a frame head piece.

6. A header according to claim 3 wherein both of said side walls terminate in an outwardly projecting flange potion with said flange portions projecting oppositely one another.

7. A header according to claim 6 wherein a respective said flange portion and each respective said frame plate associated therewith together define a frame head piece.

8. A header according to claim 2 wherein said housing includes at least one frame head piece.

9. A header according to claim 2 including at least one cover plate adapted to mount onto said housing to enclose the interior thereof.

10. A header according to claim 9 including a sub-housing structure adapted to mount onto said cover plate, said crank arm extending laterally through a slot formed in said sub-housing structure.

11. A header according to claim 10 wherein said sub-housing structure defined a top strike for the door.

12. A header according to claim 2 wherein said housing includes at least one end wall.

13. A header according to claim 1 wherein said operator is mounted on a mounting plate and including at least one hanger bracket secured to said housing in the interior thereof, said hanger bracket operative to support said mounting plate.

14. A header according to claim 1 wherein said operator includes an electrical motor.

15. A header according to claim 14 wherein said housing includes a knock-out portion adapted upon removal to allow access for electrical connections to said operator from a power supply.

16. A door frame assembly adapted to mount an automatic door that includes an automatic electrical operator associated therewith, comprising:
(A) a first side jamb;
(B) a second side jamb; and
(C) a header housing extending between said first and second jambs, said header housing having a header interior sized and adapted to receive and mount the operator therein whereby said operator is located above the door inside of said header housing when the door is mounted in said door frame.

17. A door frame assembly according to claim 16 wherein said housing is formed in an inverted U-shaped configuration including a pair of opposed side walls and a top wall interconnecting said side walls.

18. A door frame assembly according to claim 17 wherein said housing includes a frame head piece on each opposite side thereof.

19. A door frame assembly according to claim 18 wherein each of said side walls terminates in an outwardly projecting flange potion with said flange portions projecting oppositely one another.

20. A door frame assembly according to claim 19 including a frame plate secured to each of said flange portions thereby to define a respective said frame head piece.

21. A door frame assembly according to claim 17 including at least one cover plate adapted to mount onto said housing to enclose the interior thereof.

22. A door frame assembly according to claim 21 including a sub-housing structure adapted to mount onto said cover plate, said crank arm extending laterally through a slot formed in said sub-housing structure.

23. A door frame assembly according to claim 2 wherein said housing includes at least one end wall, said end wall being formed as an integral extension of one of said hinge jamb and said strike jamb.

24. A door frame assembly according to claim 16 wherein said housing includes a knock-out portion adapted upon removal to allow access for electrical connections to said operator from a power supply.

25. A automatic door system for use in a door opening in a wall and adapted to be connected to a power supply, comprising:
(A) a frame adapted to mount in the door opening, said frame including
(1) first and second side jambs, and
(2) a header housing extending between said side jambs, said header housing having a header interior;
(B) at least one door mounted in said frame for movement between an open position and a closed position;
(C) an operator disposed in the header interior; and
(D) a crank arm linking said operator and said door whereby said operator operatively acts on said door thereby to move said door from the closed position to the open position.

26. A automatic door system according to claim 25 including a pair of doors mounted in said frame, each for movement between an open position and a closed position, and including an operator associated with each of said doors, each said operator received in said housing interior.

27. A automatic door system according to claim 25 wherein said housing is formed in an inverted U-shaped configuration including a pair of opposed side walls and a top wall interconnecting said side walls.

28. A automatic door system according to claim 27 wherein said housing includes a frame head piece on each opposite side thereof.

29. A automatic door system according to claim 28 wherein each of said side walls terminates in an outwardly projecting flange potion with said flange portions projecting oppositely one another.

30. A automatic door system according to claim 25 including at least one cover plate adapted to mount onto said housing to enclose the interior thereof.

31. A automatic door system according to claim 30 including a sub-housing structure adapted to mount onto said cover plate, said crank arm extending laterally through a slot formed in said sub-housing structure.

32. A automatic door system according to claim 25 wherein said operator is mounted on a mounting plate and including at least one hanger bracket secured to said housing in the interior thereof, said hanger bracket operative to support said mounting plate.

33. A automatic door system according to claim 25 including a sensor operative to sense the presence of a person seeking access to said door, said sensor operative to actuator said operator to move the door from the open to the closed position.

34. In an automatic door system mounted in a wall and including a door mounted in a frame for movement between an open position and a closed position, an operator including a crank arm linking said operator and said door whereby said operator operatively acts on said door thereby to move said door from the closed position to the open position when said crank arm moves from the first position to the second position and sensor operative to actuate the operator, the improvement comprising a header housing having an interior defining a portion of said frame, said header housing extending across said door when said door is in the closed position with said operator being disposed substantially in the interior of said header housing.
